(19) United States
(12) Patent Application Publication
(10) Pub. No.: US 2023/0267148 A1
(43) Pub. Date: Aug. 24, 2023

(54) Automated Query Analysis and Remediation Tool

(71) Applicant: Bank of America Corporation, Charlotte, NC (US)

(72) Inventors: Kartheek Kotha, Plano, TX (US); Kalyani Bandaru, Allen, TX (US); Venkata P. Balijepalli, Frisco, TX (US)

(21) Appl. No.: 17/677,145

(22) Filed: Feb. 22, 2022

(51) Int. Cl. G06F 16/835; G06F 16/832

(52) U.S. Cl. CPC G06F 16/8365; G06F 16/832

(57) ABSTRACT

Aspects of the disclosure relate to an automated query analysis and remediation tool. A computing platform may receive a query for analysis. The computing platform may load an extensible markup language (XML) query execution plan for the received query. In addition, the query execution plan may include a sequence of operations used to access data in a relational database. The computing platform may shred XML data from the query execution plan into relational database tables. The computing platform may identify tuning parameters based on the shredded XML data. Based on the identified tuning parameters and using a machine learning engine, the computing platform may generate an optimized query. The computing platform may cause the optimized query to be displayed on one or more user interfaces.

### BACKGROUND

Aspects of the disclosure generally relate to one or more computer systems, servers, and/or other devices including hardware and/or software. In particular, one or more aspects of the disclosure relate to an automated query analysis and remediation tool.

Query tuning is a challenging and time consuming task that often requires expertise in various technical areas, such as a deep understanding of system configurations, planning optimization, and/or solutions for reducing CPU consumption. In many instances, users might write a query in an unoptimized way, which consumes multiple resources from a system such that the query results may be aborted, spooled out, or cancelled due to negative impact on the system. In many instances, it may be difficult to use traditional tools to efficiently tune a query on the fly and provide results in an optimized way.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with query remediation. In particular, one or more aspects of the disclosure provide techniques for automated query performance tuning. In accordance with one or more embodiments, a computing platform having at least one processor, a communication interface, and memory may receive, via the communication interface, a query for analysis. The computing platform may load an extensible markup language (XML) query execution plan for the received query. In addition, the query execution plan may include a sequence of operations used to access data in a relational database. The computing platform may shred XML data from the query execution plan into relational database tables. The computing platform may identify tuning parameters based on the shredded XML data. Based on the identified tuning parameters and using a machine learning engine, the computing platform may generate an optimized query. The computing platform may cause the optimized query to be displayed on one or more user interfaces.

In some embodiments, generating the optimized query may include providing the identified tuning parameters to a classification algorithm, and identifying, via the classification algorithm, problem parameters.

In some arrangements, the identified tuning parameters may include parameters associated with one or more of: spool space, non-compliant steps, stale statistics, skew of an object, null analysis, user defined function (UDF) usage, or join conditions.

In some examples, generating the optimized query may include generating one or more recommendations for remediating the query.

In some embodiments, causing the optimized query to be displayed on one or more user interfaces may include applying the one or more recommendations to the query.

In some example arrangements, receiving the query may include receiving the query input on a graphical user interface of a computing device.

In some examples, the computing platform may receive user feedback and tune the machine learning engine based on the user feedback.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for automated query analysis and remediation in accordance with one or more example embodiments;

FIGS. 2A-2D depict an illustrative event sequence for automated query analysis and remediation in accordance with one or more example embodiments;

FIGS. 3 and 4 depict example graphical user interfaces for automated query analysis and remediation in accordance with one or more example embodiments; and

FIG. 5 depicts an illustrative method for automated query analysis and remediation in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure relate to a query performance tuning tool. In particular, one or more aspects of the disclosure provide a query assistance tool that intakes queries, analyzes them to see if there will be any issues when they are executed, and then outputs an optimized query. In some embodiments, the tool may be used by users of the data warehouse to optimize queries before they are executed. Additional aspects of the disclosure may predicate flaws and assist in tuning recommendations using machine/deep learning algorithms, and/or apply query re-write patterns. Further aspects of the disclosure may dynamically optimize and/or tune a machine learning engine that generates the optimized queries.

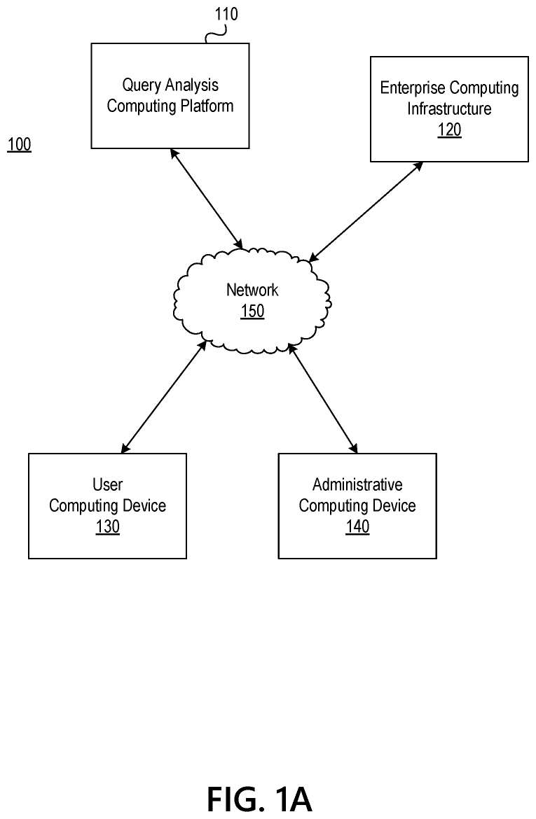

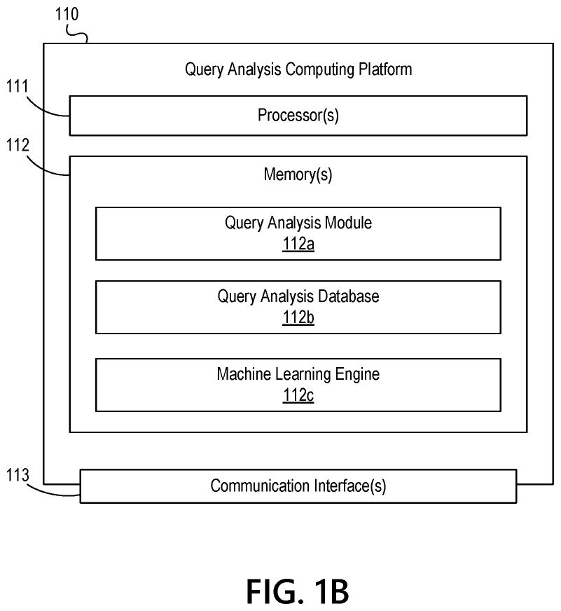

FIGS. 1A and 1B depict an illustrative computing environment for automated query analysis and remediation in accordance with one or more example embodiments. Referring to FIG. 1A, computing environment 100 may include one or more computing devices and/or other computing systems. For example, computing environment 100 may include query analysis computing platform 110, enterprise computing infrastructure 120, user computing device 130, and administrative computing device 140. Although one user computing device 130 is shown for illustrative purposes, any number of user computing devices may be used without departing from the disclosure.

As illustrated in greater detail below, query analysis computing platform 110 may include one or more computing devices configured to perform one or more of the functions described herein. For example, query analysis computing platform 110 may include one or more computers (e.g., laptop computers, desktop computers, servers, server blades, or the like) that may be used to analyze and tune a query, provide an optimized query, and/or provide recommendations for optimizing the query, all in real time or near real-time. In some examples, query analysis computing platform 110 may host a GUI based tool for automated query analysis and remediation. The tool may analyze steps of a query execution plan against current system configurations, log histories, user profiles, and/or relational set operators being used, perform a deep dive/analysis on impacted data, and/or compare allocated versus required spool space, among other functions.

Enterprise computing infrastructure 120 may include one or more computer servers, networks, platforms, and/or cloud-based services (which may, e.g., be used to support operations and/or other functions of an enterprise organization operating query analysis computing platform 110, such as a financial institution). For example, enterprise computing infrastructure 120 may include various servers and/or databases that store and/or otherwise maintain database tables, staging areas, and/or other query related information.

User computing device 130 may include one or more end user computing devices and/or other computer components (e.g., processors, memories, communication interfaces) used by developers interacting with the query analysis computing platform 110 hosting a GUI based tool. For example, a GUI based tool for inputting a query on a webpage may run in the background to read a query, analyze the query, apply recommendations, and provide an output (e.g., an optimized rewritten query) to the user.

Administrative computing device 140 may include one or more computing devices and/or other computer components (e.g., processors, memories, communication interfaces) used to manage the query analysis computing platform 110. For instance, administrative computing device 140 may be a server, desktop computer, laptop computer, tablet, mobile device, or the like, and may be associated with an enterprise organization operating query analysis computing platform 110. In some examples, administrative computing device 140 may be used to manage the GUI based tool (e.g., the tool's operations, maintenance, and/or other tasks).

Computing environment 100 also may include one or more networks, which may interconnect one or more of query analysis computing platform 110, enterprise computing infrastructure 120, user computing device 130, and administrative computing device 140. For example, computing environment 100 may include network 150. Network 150 may include one or more sub-networks (e.g., local area networks (LANs), wide area networks (WANs), or the like). For example, network 150 may include a private sub-network that may be associated with a particular organization (e.g., a corporation, financial institution, educational institution, governmental institution, or the like) and that may interconnect one or more computing devices associated with the organization. For example, query analysis computing platform 110, enterprise computing infrastructure 120, and administrative computing device 140 may be associated with an organization (e.g., a financial institution), and network 150 may be associated with and/or operated by the organization, and may include one or more networks (e.g., LANs, WANs, virtual private networks (VPNs), or the like) that interconnect query analysis computing platform 110, enterprise computing infrastructure 120, and administrative computing device 140. Network 150 also may include a public sub-network that may connect the private sub-network and/or one or more computing devices connected thereto (e.g., query analysis computing platform 110, enterprise computing infrastructure 120, and administrative computing device 140) with one or more networks and/or computing devices that are not associated with the organization (e.g., user computing device 130).

In one or more arrangements, query analysis computing platform 110, enterprise computing infrastructure 120, user computing device 130, and administrative computing device 140 may be any type of computing device capable of receiving a user interface, receiving input via the user interface, and communicating the received input to one or more other computing devices. For example, query analysis computing platform 110, enterprise computing infrastructure 120, user computing device 130, administrative computing device 140, and/or the other systems included in computing environment 100 may, in some instances, include one or more processors, memories, communication interfaces, storage devices, and/or other components. As noted above, and as illustrated in greater detail below, any and/or all of the computing devices included in computing environment 100 may, in some instances, be special-purpose computing devices configured to perform specific functions.

Referring to FIG. 1B, query analysis computing platform 110 may include one or more processor(s) 111, memory(s) 112, and communication interface(s) 113. A data bus may interconnect processor 111, memory 112, and communication interface 113. Communication interface 113 may be a network interface configured to support communication between query analysis computing platform 110 and one or more networks (e.g., network 150 or the like). Memory 112 may include one or more program modules having instructions that when executed by processor 111 cause query analysis computing platform 110 to perform one or more functions described herein and/or one or more databases and/or other libraries that may store and/or otherwise maintain information which may be used by such program modules and/or processor 111.

In some instances, the one or more program modules and/or databases may be stored by and/or maintained in different memory units of query analysis computing platform 110 and/or by different computing devices that may form and/or otherwise make up query analysis computing platform 110. For example, memory 112 may have, store, and/or include a query analysis module 112a, a query analysis database 112b, and a machine learning engine 112c. Query analysis module 112a may have instructions that direct and/or cause query analysis computing platform 110 to, for instance, provide a GUI based tool for optimizing queries and/or instructions that direct query analysis computing platform 110 to perform other functions, as discussed in greater detail below. Query analysis database 112b may store information used by query analysis module 112a and/or query analysis computing platform 110 in optimizing queries and/or in performing other functions, as discussed in greater detail below. Machine learning engine 112c may have instructions that direct and/or cause query analysis computing platform 110 to set, define, and/or iteratively redefine rules, techniques and/or other parameters used by query analysis computing platform 110 and/or other systems in computing environment 100 in optimizing queries and/or in performing other functions, as discussed in greater detail below.

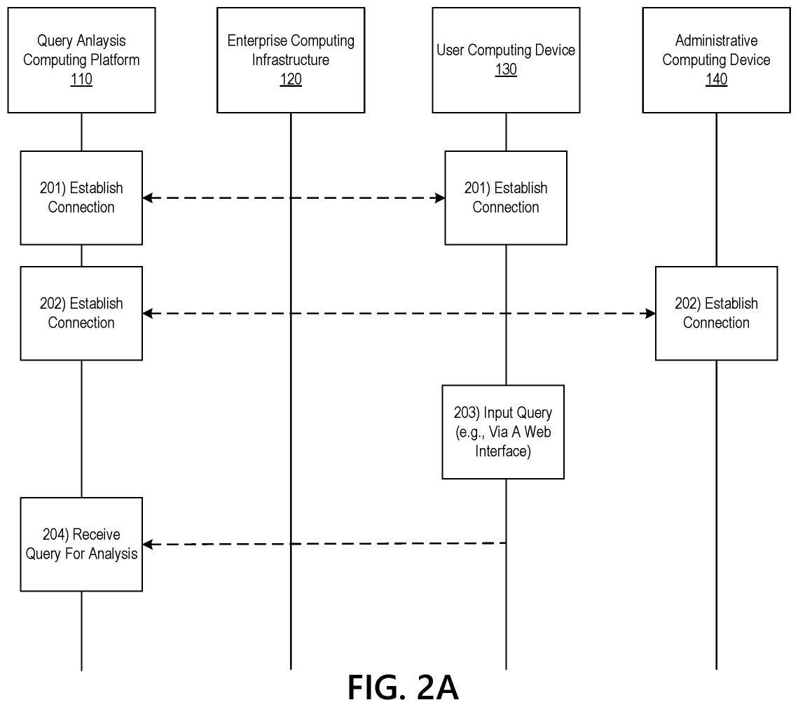

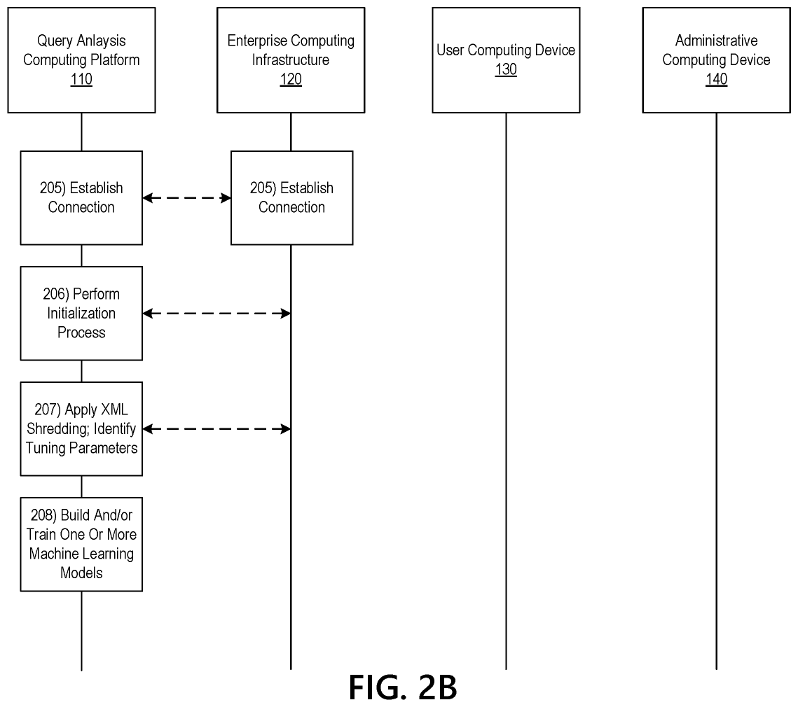

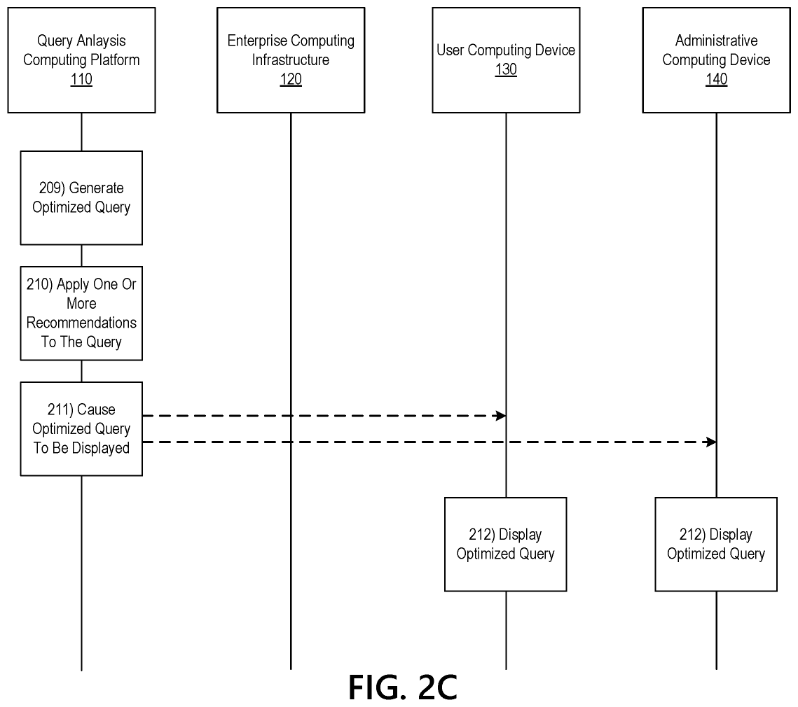

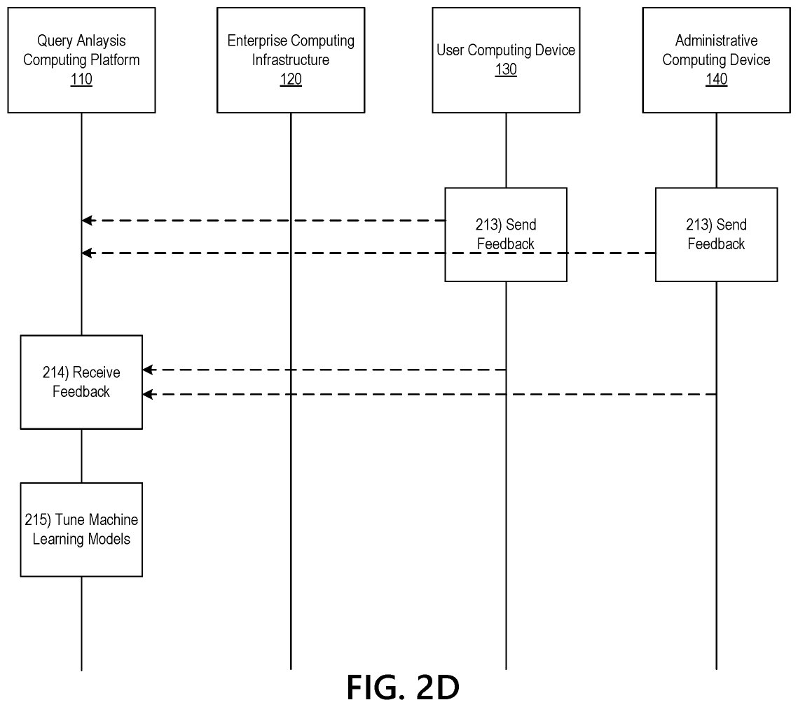

FIGS. 2A-2D depict an illustrative event sequence for query analysis in accordance with one or more example embodiments. Referring to FIG. 2A, at step 201, a user of a computing device (e.g., user computing device 130) may establish a connection with query analysis computing platform 110. For example, the user of the computing device (e.g., user computing device 130) may establish a first wireless data connection with query analysis computing platform 110 to link query analysis computing platform 110 with the user of the computing device (e.g., user computing device 130) (e.g., in preparation for sending input queries). In some instances, the user of the computing device (e.g., user computing device 130) may identify whether or not a connection is already established with query analysis computing platform 110. If a connection is already established with query analysis computing platform 110, the user of the computing device (e.g., user computing device 130) might not re-establish the connection. If a connection is not yet established with query analysis computing platform 110, the user of the computing device (e.g., user computing device 130) may establish the first wireless data connection as described above.

At step 202, a user of an administrative computing device (e.g., administrative computing device 140) may establish a connection with query analysis computing platform 110. For example, the user of the computing device (e.g., administrative computing device 140) may establish a second wireless data connection with query analysis computing platform 110 to link query analysis computing platform 110 with the user of the computing device (e.g., administrative computing device 140). In some instances, the user of the computing device (e.g., administrative computing device 140) may identify whether or not a connection is already established with query analysis computing platform 110. If a connection is already established with query analysis computing platform 110, the user of the computing device (e.g., administrative computing device 140) might not re-establish the connection. If a connection is not yet established with query analysis computing platform 110, the user of the computing device (e.g., administrative computing device 140) may establish the second wireless data connection as described above.

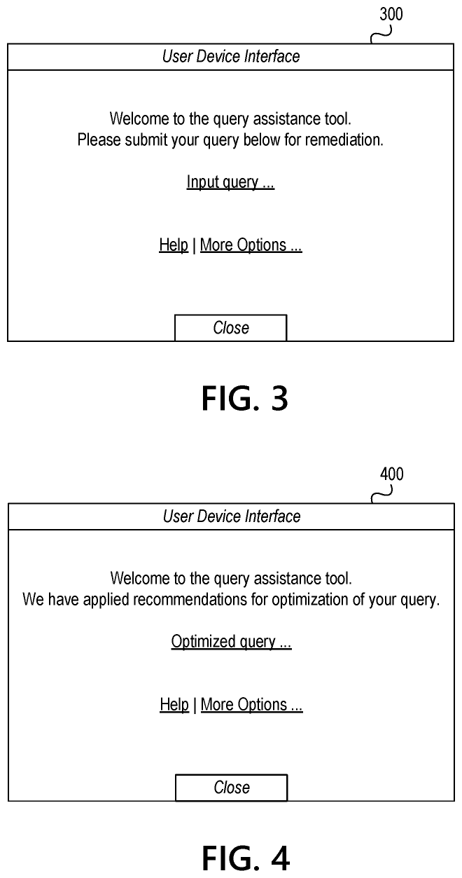

At step 203, a user may input a query (e.g., via a web interface). In some examples, the query may be input on a graphical user interface (GUI) of a computing device (e.g., user computing device 130). In some examples, the computing device (e.g., user computing device 130) may be a developer computing device. In some arrangements, query analysis computing platform 110 may cause the user computing device (e.g., user computing device 130) to display and/or otherwise present one or more graphical user interfaces similar to graphical user interface 300, which is illustrated in FIG. 3. As seen in FIG. 3, graphical user interface 300 may include text and/or other information associated with query assistance, including allowing a user to input a query for analysis (e.g., “Welcome to the query assistance tool. Please submit your query below for remediation. [Input query . . . ]”). It will be appreciated that other and/or different notifications may also be provided.

At step 204, query analysis computing platform 110 may receive, via the communication interface (e.g., communication interface 113) and while the first wireless data connection is established, the input query (e.g., an SQL query) for analysis.

With reference to FIG. 2B, at step 205, query analysis computing platform 110 may establish a connection with enterprise computing infrastructure 120. For example, query analysis computing platform 110 may establish a third wireless data connection with enterprise computing infrastructure 120 to link query analysis computing platform 110 with enterprise computing infrastructure 120. In some instances, query analysis computing platform 110 may identify whether or not a connection is already established with enterprise computing infrastructure 120. If a connection is already established with enterprise computing infrastructure 120, query analysis computing platform 110 might not re-establish the connection. If a connection is not yet established with the enterprise computing infrastructure 120, query analysis computing platform 110 may establish the third wireless data connection as described above.

At step 206, while the third wireless data connection is established, query analysis computing platform 110 may execute an initialization process. For instance, query analysis computing platform 110 may load an extensible markup language (XML) query execution plan (e.g., also referred to as an “explain plan” or “execution plan”) for the received query (e.g., into a staging area). An explain plan is a user-viewable representation of the query execution plan. A query execution plan may include a sequence of operations used to access data in a relational database (e.g., a sequence of steps used to access data in a SQL (Structured Query Language) relational database management system). In some examples, query analysis computing platform 110 may store the XML explain plan in a character large object (CLOB) format.

A step 207, while the third wireless data connection is established, query analysis computing platform 110 may execute an XML shredding process. For instance, query analysis computing platform 110 may shred XML data from the query execution plan into relational database tables (e.g., populating the relational database tables with the shredded XML data). For instance, the XML shredding process may parse the explain plan which is in XML format and extract information for analyzing the query (e.g., the tables/objects being used, the filters being applied (e.g., in a particular query), the indexes being used (e.g., defined for a particular table), the columns on which joins are being done, and/or the like). In some examples, by applying XML shredding, performance tuning/remediation parameters associated with one or more of: spool space, non-compliant steps, stale statistics, skew of an object, null analysis, user defined function (UDF) usage, or join conditions, may be identified.

At step 208, query analysis computing platform 110 may build and/or train one or more machine learning models. For example, memory 112 may have, store, and/or include historical/training data. In some examples, query analysis computing platform 110 may receive historical and/or training data and use that data to train one or more machine learning models stored in machine learning engine 112c. The historical and/or training data may include, for instance, database system metadata, query log data, and/or the like. The data may be gathered and used to build and train one or more machine learning models executed by machine learning engine 112c to identify one or more recommendations for remediating a query (e.g., adding limitations to a query, narrowing a query, etc.).

Referring to FIG. 2C, after building and/or training the one or more machine learning models, machine learning engine 112c may receive data from various sources and execute the one or more machine learning models to generate an output, such as an optimized query. For example, at step 209, based on the identified tuning parameters and using a machine learning engine (e.g., machine learning engine 112c), query analysis computing platform 110 may generate the optimized query. In generating the optimized query, query analysis computing platform 110 may provide the identified performance tuning parameters (e.g., from the shredding process at step 207) as input to a classification algorithm. The resulting classification model may identify problem parameters and propose solutions and/or tweaks to the query to fix those problems.

In some examples, the optimized query may include one or more recommendations for remediating the query. For instance, in detecting at least a threshold number of nulls in the columns being joined, query analysis computing platform 110 might recommend and/or apply a “not null” condition or constraint when rewriting the query. In another example, in detecting at least a threshold number of duplicate records, query analysis computing platform 110 might recommend removal of and/or remove the duplicates before performing a join operation. In another example, in detecting inappropriate indexing, query analysis computing platform 110 might recommend and/or create missing indexes.

In some examples, at step 210, query analysis computing platform 110 may automatically apply the one or more recommendations to the query. For instance, query analysis platform 110 may automatically modify one or more queries to include the generated recommendations. At step 211, query analysis computing platform 110 may cause the optimized query to be displayed on one or more user interfaces (e.g., on a display device of user computing device 130 or administrative computing device 140). In turn, at step 212, user computing device 130 and/or administrative computing device 140 may display the optimized query. For example, query analysis computing platform 110 may cause the user device (e.g., user computing device 130 or administrative computing device 140) to display and/or otherwise present one or more graphical user interfaces similar to graphical user interface 400, which is illustrated in FIG. 4. As seen in FIG. 4, graphical user interface 400 may include text and/or other information associated with providing optimized queries and/or query recommendations (e.g., “Welcome to the query assistance tool. We have applied recommendations for optimization of your query. [Optimized query . . . ]”). It will be appreciated that other and/or different notifications may also be provided. In this way, for example, queries may be analyzed in an automated way and any problems which are detected may be fixed or remediated before they occur.

Referring to FIG. 2D, in some embodiments, at step 213, the user device (e.g., user computing device 130 or administrative computing device 140) may send, via the communication interface (e.g., communication interface 113) and while the first and/or second wireless data connection is established, feedback (e.g., user feedback) to query analysis computing platform 110. At step 214, query analysis computing platform 110 may receive, via the communication interface (e.g., communication interface 113) and while the first and/or second wireless data connection is established, the user feedback (e.g., from user computing device 130 and/or administrative computing device 140). In turn, at step 215, query analysis computing platform 110 may tune the machine learning engine (e.g., based on historical data or user feedback received from users).

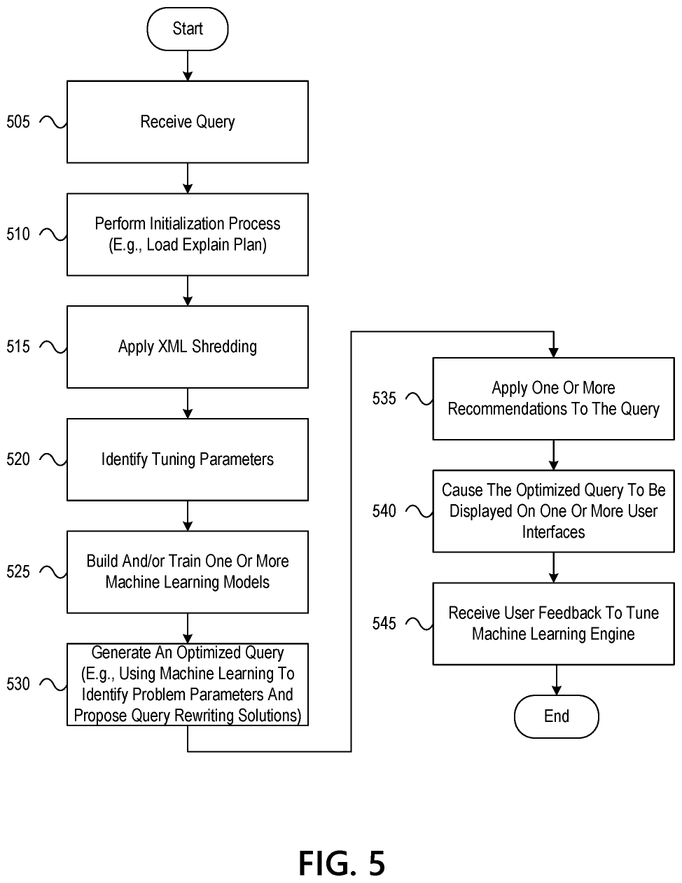

FIG. 5 depicts an illustrative method for automated query analysis and remediation. Referring to FIG. 5, at step 505, a computing platform having at least one processor, a communication interface, and memory may receive a query for analysis. At step 510, the computing platform may load an extensible markup language (XML) query execution plan for the received query. In addition, the query execution plan may include a sequence of operations used to access data in a relational database. At step 515, the computing platform may shred XML data from the query execution plan into relational database tables. At step 520, the computing platform may identify tuning parameters based on the shredded XML data. At step 525, the computing platform may build and/or train one or more machine learning models. At step 530, based on the identified tuning parameters and using a machine learning engine, the computing platform may generate an optimized query. In some embodiments, at step 535, the computing platform may apply one or more recommendations for remediating the query. At step 540, the computing platform may cause the optimized query to be displayed on one or more user interfaces. In some embodiments, at step 545, the computing platform may receive user feedback and tune and/or improve the machine learning engine.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

What is claimed is:

1. A computing platform, comprising:
at least one processor;
a communication interface communicatively coupled to the at least one processor; and
memory storing computer-readable instructions that, when executed by the at least one processor, cause the computing platform to:
receive, via the communication interface, a query for analysis;
load an extensible markup language (XML) query execution plan for the received query, wherein the query execution plan comprises a sequence of operations used to access data in a relational database;
shred XML data from the query execution plan into relational database tables;
identify tuning parameters based on the shredded XML data;
generate, based on the identified tuning parameters and using a machine learning engine, an optimized query; and
cause the optimized query to be displayed on one or more user interfaces.

2. The computing platform of claim 1, wherein generating the optimized query comprises:
providing the identified tuning parameters to a classification algorithm; and
identifying, via the classification algorithm, problem parameters.

3. The computing platform of claim 2, wherein the identified tuning parameters comprise parameters associated with one or more of: spool space, non-compliant steps, stale statistics, skew of an object, null analysis, user defined function (UDF) usage, or join conditions.

4. The computing platform of claim 1, wherein generating the optimized query comprises generating one or more recommendations for remediating the query.

5. The computing platform of claim 4, wherein causing the optimized query to be displayed on one or more user interfaces comprises applying the one or more recommendations to the query.

6. The computing platform of claim 1, wherein receiving the query comprises receiving the query input on a graphical user interface of a computing device.

7. The computing platform of claim 1, wherein the memory stores additional computer-readable instructions that, when executed by the at least one processor, cause the computing platform to:
receive user feedback; and
tune the machine learning engine based on the user feedback.

8. A method, comprising:
at a computing platform comprising at least one processor, a communication interface, and memory:
receiving, by the at least one processor, via the communication interface, an input query for analysis;
loading, by the at least one processor, an extensible markup language (XML) query execution plan for the received query, wherein the query execution plan comprises a sequence of operations used to access data in a relational database;
shredding, by the at least one processor, XML data from the query execution plan into relational database tables;
identifying, by the at least one processor, tuning parameters based on the shredded XML data;
generating, by the at least one processor, based on the identified tuning parameters and using a machine learning engine, an optimized query; and
causing, by the at least one processor, the optimized query to be displayed on one or more user interfaces.

9. The method of claim 8, wherein generating the optimized query comprises:
providing, by the at least one processor, the identified tuning parameters to a classification algorithm; and
identifying, by the at least one processor, via the classification algorithm, problem parameters.

10. The method of claim 9, wherein the identified tuning parameters comprise parameters associated with one or more of: spool space, non-compliant steps, stale statistics, skew of an object, null analysis, user defined function (UDF) usage, or join conditions.

11. The method of claim 8, wherein generating the optimized query comprises generating one or more recommendations for remediating the input query.

12. The method of claim 11, wherein causing the optimized query to be displayed on one or more user interfaces comprises applying the one or more recommendations to the input query.

13. The method of claim 8, wherein receiving the query comprises receiving the query input on a graphical user interface of a computing device.

14. The method of claim 8, further comprising:
receiving, by the at least one processor, user feedback; and
tuning, by the at least one processor, the machine learning engine based on the user feedback.

15. One or more non-transitory computer-readable media storing instructions that, when executed by a computing platform comprising at least one processor, a communication interface, and memory, cause the computing platform to:
receive, via the communication interface, an input query for analysis;
load an extensible markup language (XML) query execution plan for the received query, wherein the query execution plan comprises a sequence of operations used to access data in a relational database;
shred XML data from the query execution plan into relational database tables;
identify tuning parameters based on the shredded XML data;
generate, based on the identified tuning parameters and using a machine learning engine, an optimized query; and
cause the optimized query to be displayed on one or more user interfaces.

16. The one or more non-transitory computer-readable media of claim 15, wherein generating the optimized query comprises:
providing the identified tuning parameters to a classification algorithm; and
identifying, via the classification algorithm, problem parameters.

17. The one or more non-transitory computer-readable media of claim 16, wherein the identified tuning parameters comprise parameters associated with one or more of: spool space, non-compliant steps, stale statistics, skew of an object, null analysis, user defined function (UDF) usage, or join conditions.

18. The one or more non-transitory computer-readable media of claim 15, wherein generating the optimized query comprises generating one or more recommendations for remediating the input query.

19. The one or more non-transitory computer-readable media of claim 18, wherein causing the optimized query to be displayed on one or more user interfaces comprises applying the one or more recommendations to the query.

20. The one or more non-transitory computer-readable media of claim 15, wherein receiving the query comprises receiving the query input on a graphical user interface of a computing device.
